(19) United States
(12) Patent Application Publication
(10) Pub. No.: US 2015/0292201 A1
(43) Pub. Date: Oct. 15, 2015

(54) LEAD-BASED PROTECTIVE SHIELDING SYSTEM

(71) Applicant: Gary A. Simson, Phoenix, AZ (US)

(72) Inventor: Gary A. Simson, Phoenix, AZ (US)

(73) Assignee: PB LAMINATIONS AND SPECIALTY SUPPLY LLC, Phoenix, AZ (US)

(21) Appl. No.: 14/249,303

(22) Filed: Apr. 9, 2014

(51) Int. Cl. E04B 1/92; G21F 1/08

(52) U.S. Cl. CPC E04B 1/92; G21F 1/085; E04B 2001/925; E04B 2103/06

(57) ABSTRACT

A device useful to block radiation (e.g., X-ray, gamma ray) leakage through a wall joint and screw holes in a lead-shielded structure is provided. The device includes a substantially planar lead strip which is at least the thickness of the lead sheeting covering the structure, and a lead strip holder adapted to hold the lead strip securely in place and attach the lead strip to a metal C stud such that when attached thereto, the lead strip forms a barrier which blocks radiation leaking through the wall joint and adjacent screw holes. Clips can be used to attach the lead strip holder to the stud, wherein each of the clips includes a U-shaped portion to frictionally fit onto a U-shaped portion of the lead strip holder. In various embodiments, the device can be used on vertical or horizontal wall joints.

### BACKGROUND OF THE INVENTION

1. Field of the Invention

The present invention relates to lead-based protective shielding systems.

2. Description of the Related Art

The most important property of a shielding material for use in countering the effects of X-ray and gamma rays is the density of the material. Although lead is not the densest element, lead is readily available and has the lowest cost of the higher density materials. It is also relatively easy to work with and is resistant to contamination from dirt and other materials.

Lead shielding in the form of lead sheets or plates is widely used in hospitals, laboratories and industrial facilities. For example, the walls of a typical X-ray room are surrounded with lead sheeting to prevent radiation leakage. Such lead sheeting requires adequate support, so the lead sheets are usually attached to a substrate such as plywood or gypsum board.

However, conventional methods for installing lead-based protective shielding to walls are time consuming and/or wasteful. In one traditional method, the installer must countersink drywall screws into a lead-laminated gypsum board when fastening it to the wall studs, and once the drywall screws are countersunk, lead screw plugs are placed over each of the screws so that radiation cannot leak through. Additionally, 2″ batten lead strips are installed over each of the vertical wall joints.

Lead plugs and batten strips become difficult to use when lead thickness is greater than about an eighth of an inch. In the prior art, angled lead plates of the same thickness or greater than the lead sheet have been used instead. Such an angled lead plate is a narrow piece of lead sheet which is bent at a right angle such that one leg becomes a mounting portion fastened to the inside portion of a wall stud and the other leg extends sufficiently to act as a barrier to prevent radiation leakage at the joint and screw holes. However, installing angled lead plates can be very difficult. Additionally, angled lead plates often block access for wiring and plumbing in the wall.

### SUMMARY OF THE INVENTION

A device useful to block radiation (e.g., X-ray, gamma ray) leakage through a wall joint and screw holes in a lead-shielded structure is provided. The device includes a substantially planar lead strip which is at least the thickness of the lead sheeting covering the structure, and a lead strip holder adapted to hold the lead strip securely in place and attach the lead strip to a metal C stud such that when attached thereto, the lead strip forms a barrier which blocks radiation leaking through the wall joint and screw holes. Clips can be used to attach the lead strip holder to the stud, wherein each of the clips includes a U-shaped portion to frictionally fit onto a U-shaped portion of the lead strip holder. In another embodiment, the device can be placed horizontally to block radiation leakage through a horizontal wall joint and screw holes. In this case, the radiation blocking device includes a metal C stud arranged vertically, and a substantially planar lead strip arranged horizontally and extending through the stud. The radiation blocking device may further include an extension piece attached to an outer portion of the stud. The lead strip holder may include a main body adapted to hold the lead strip substantially parallel to a wall attached to the stud and a leg adapted to be attached to the extension piece. Additionally, a clip adapted to secure the lead strip holder to the extension piece can be used.

### BRIEF DESCRIPTION OF THE DRAWINGS

FIG. 1 illustrates a prior art installation of a lead-based protective shielding system to framed walls;

FIG. 2 illustrates a cross-sectional view of the prior art system at a wall joint using batten lead strips and lead screw plugs;

FIG. 3 illustrates a cross-sectional view of an alternate prior art system showing use of an angled lead plate;

FIG. 4 illustrates a cross-sectional radiation blocking device showing use of a novel radiation blocking device, according to an embodiment of the present invention;

FIG. 5A illustrates cross-sectional views of a lead strip holder and a clip, which are parts of the radiation blocking device;

FIG. 5B illustrates a cross-sectional view of the radiation blocking device assembled, according to an embodiment of the present invention;

FIG. 6 illustrates an isometric view of the radiation blocking device installed on a lead-lined substrate;

FIG. 7 illustrates a cross-sectional view of an installation of the lead-based protective shielding system including instances of the radiation blocking device, according to an embodiment of the present invention; and

FIG. 8 illustrates a side view of the radiation blocking device arranged horizontally, according to another embodiment of the present invention.

### DETAILED DESCRIPTION OF THE INVENTION

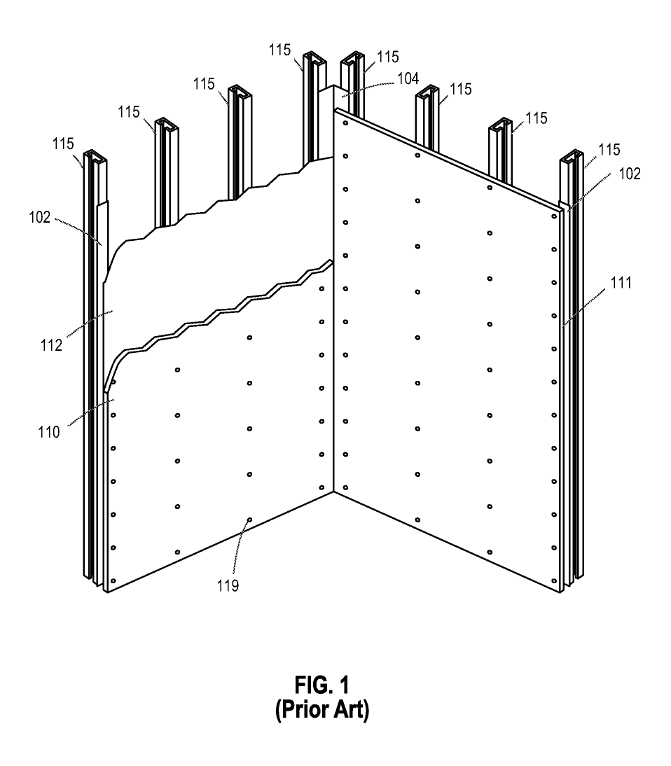

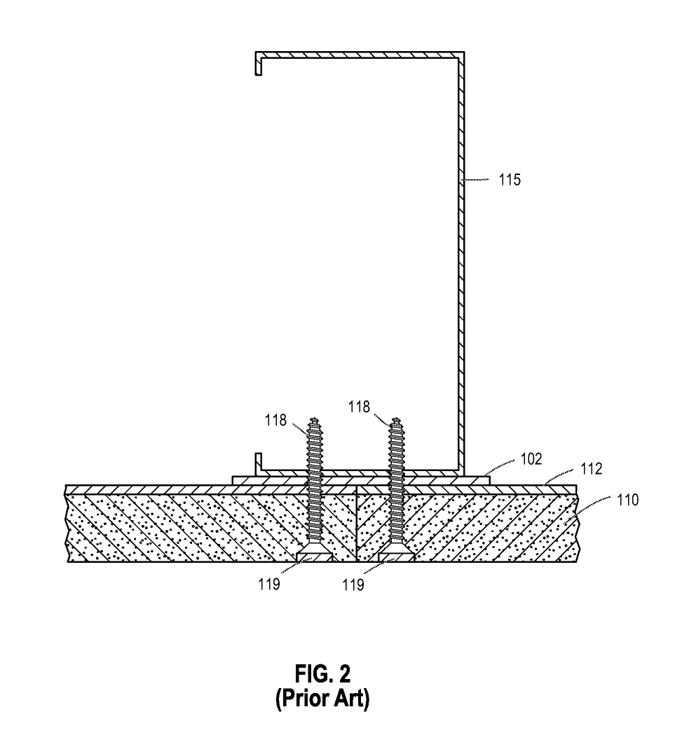

Referring to FIG. 1, a prior art installation of a lead-based protective shielding system to framed walls is illustrated. As shown, each wall section is constructed with a lead-lined gypsum wallboard (drywall) 111. The lead-lined gypsum wallboard 111 includes gypsum wallboard 110 glued on the back side to a lead sheet 112. The gypsum wall board 111 can be 48 inches in width and from eight to twelve feet in height, for example. It is recommended that the lead-lined gypsum wallboard 111 be fastened at a minimum of 8″ on center at the edges of each sheet, and at a minimum of 12″ on center at the intermediate studs with drywall screws. To avoid radiation leakage, additional measures are taken. For example, thin (e.g., 2″ in width) batten lead strips 102 can be installed over each of the vertical wall joints and lead corner ribbons 104 are installed at the corners. Additionally, the installer must countersink drywall screws 118 into the lead-laminated gypsum board 111 (as illustrated in FIG. 2) when fastening each lead-laminated gypsum board 111 to the wall studs 115, and once the drywall screws 118 are countersunk, lead screw plugs 119 are placed over each of the drywall screws 119 so that radiation cannot leak through the screw holes formed by screws 118.

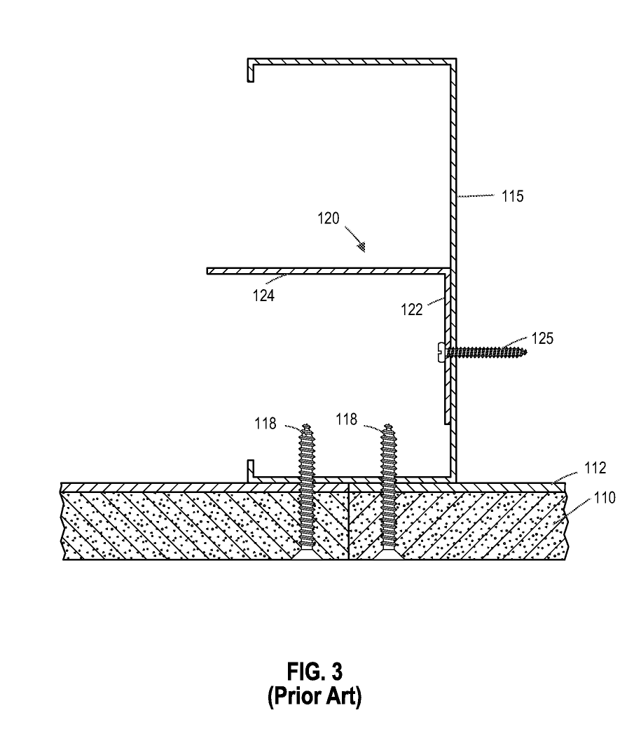

However, lead screw plugs 119 and batten strips 102 become difficult to use when lead thickness is greater than about an eighth of an inch. Angled lead plates of the same thickness or greater than the lead sheet have been used instead. Referring to FIG. 3, a cross-sectional view of an alternate prior art arrangement is illustrated. An angled lead plate 120 of the same thickness or greater than the lead sheet 112 is shown. Such an angled lead plate 120 is a strip of lead sheet which is bent at a right angle such that one leg 122 becomes a mounting portion fastened to the inside portion of a wall stud by mounting screw 125 and the other leg 124 extends sufficiently to act as a barrier to prevent radiation leakage at the joint and screw holes formed by screws 118. However, installing an angled lead plate 120 at each vertical wall joint can be very difficult. Additionally, such angled lead plates 120 often block access for wiring and plumbing in the wall.

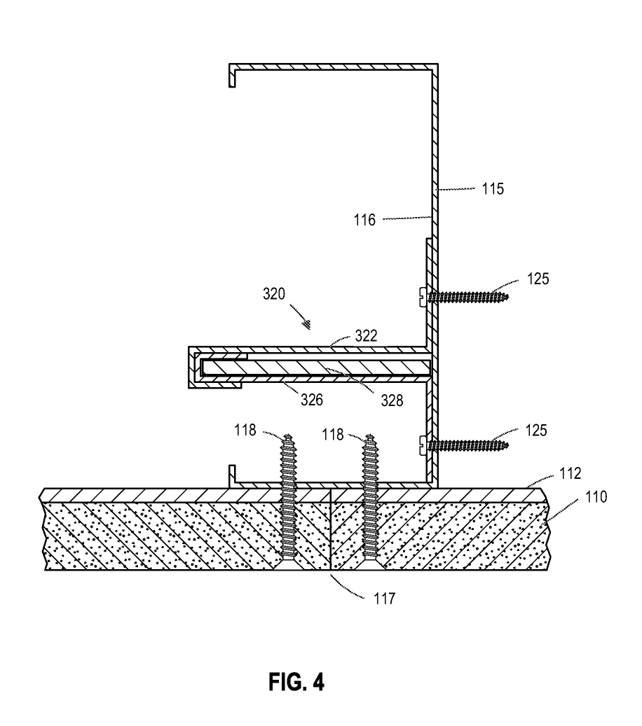

FIG. 4 illustrates a cross-sectional lead-based protective shielding system at a wall joint using a radiation blocking device 320, according to an embodiment of the present invention. The radiation blocking device 320 includes a substantially planar lead strip 328 which requires an amount of lead substantially less than the prior art angled lead plate 120. Additionally, the radiation blocking device 320 is easier to handle and install and does not block access for wiring and plumbing in the wall.

As shown, the radiation blocking device 320 includes a lead strip holder 326 which is adapted to hold the lead strip 328 securely in place and attach the lead strip 328 to an inside surface 116 of a C stud 115 such that when attached thereto, the lead strip 328 forms a barrier which blocks radiation leaking through the wall joint 117 and screw holes formed by screws 118. Additionally, a plurality of clips 322 adapted to further attach the lead strip holder 326 to the inner surface 116 of the stud 115 is shown.

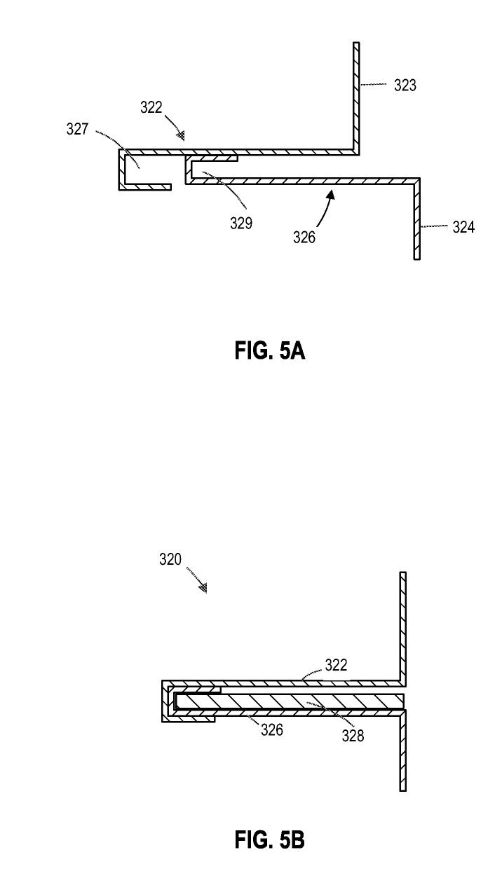

FIG. 5A illustrates cross-sectional views of the lead strip holder 326 and one of the clips 322. Each of the clips 322 includes a leg 323 adapted to attach to the inner surface 116 of the stud 115 and a U-shaped portion 327 to frictionally fit onto the U-shaped portion 329 of the lead strip holder 326. A leg 324 of the lead strip holder is also secured to the inner surface 116 of the stud 115. FIG. 5B illustrates a cross-sectional view of the radiation blocking device 320 assembled, according to an embodiment of the present invention.

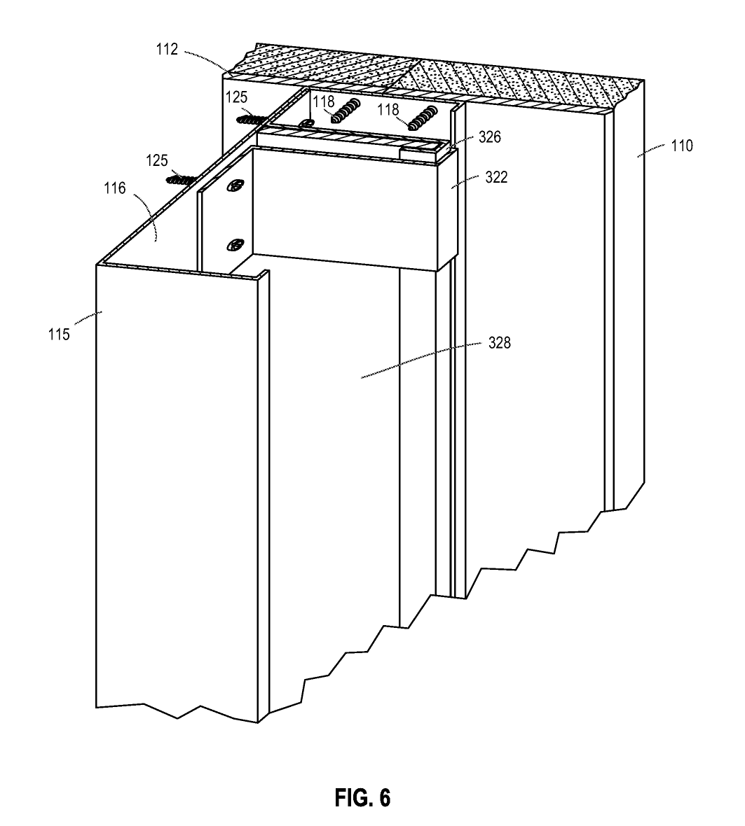

FIG. 6 illustrates an isometric view of the radiation blocking device 320 installed on a lead-lined substrate. In this case, the substrate 110 preferably includes a plywood substrate, or another substrate having the ability to support the thickness of the lead sheeting/plates chosen. The radiation blocking device 320 described herein is useful particularly when the lead sheeting is greater than about one-eighth inch in thickness and can be used for lead sheeting/plating of any thickness used in the industry.

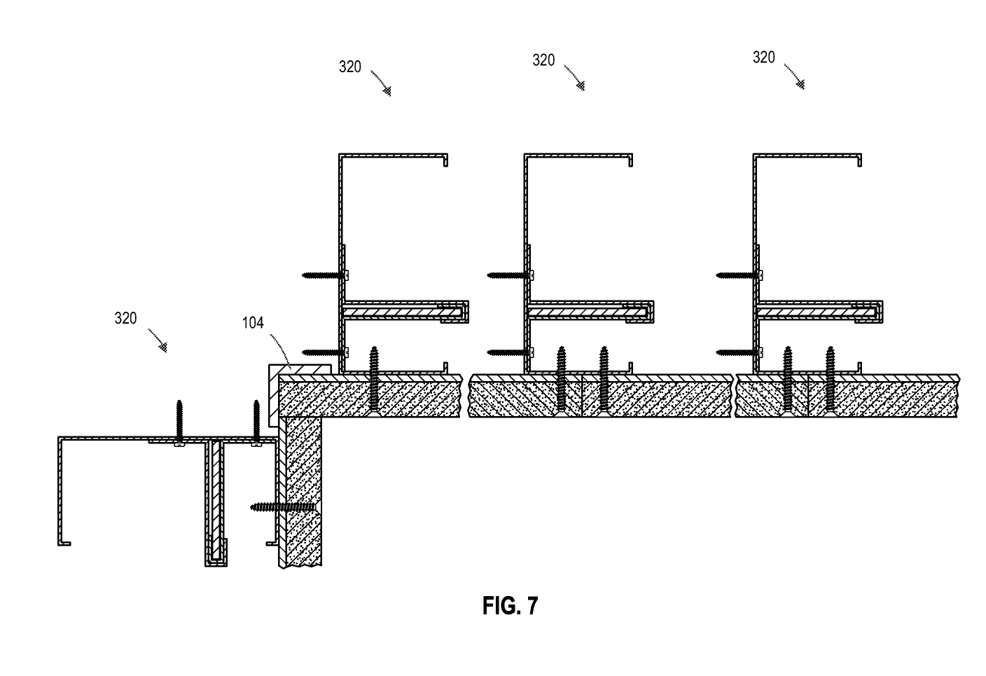

FIG. 7 illustrates a cross-sectional view of an example installation of the lead-based protective shielding system including instances of the radiation blocking device 320 installed at each wall joint.

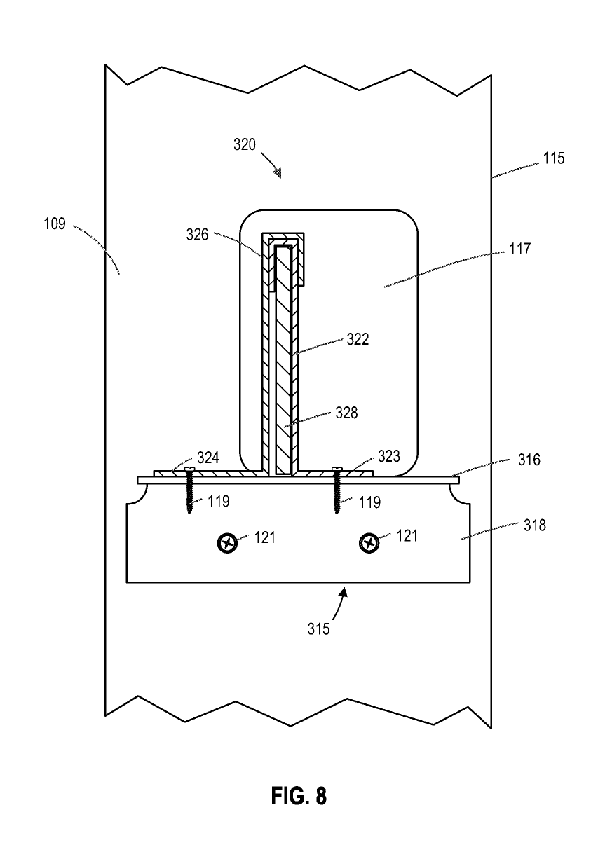

FIG. 8 illustrates a side view of an example radiation blocking device 320 arranged horizontally. In the illustrated embodiment, the radiation blocking device 320 can be placed horizontally to block radiation leakage through a horizontal wall joint (not shown). In this case, the radiation blocking device 320 includes a C stud 115 arranged vertically, and the substantially planar lead strip 328 oriented horizontally and extending through the stud 115 through an opening 117; wherein radiation from a horizontal wall joint and screw holes is blocked by the lead strip 328. The radiation blocking device 320 may further include an extension piece 318 attached to an outer portion 109 of the stud 115 using, for example, a pair of screws 121. The lead strip holder 326 may include a main body adapted to hold the lead strip 328 substantially parallel to a wall attached to the stud 115 and a leg 323 adapted to be attached to a shelf 316 of the extension piece 115 using, for example, a screw 119, as shown. Additionally, a clip 326 adapted to secure the lead strip holder 322 to the extension piece 318 can be used wherein a leg 324 of the clip attaches to the extension piece 318 using, for example, a screw 119, as shown.

While this invention has been described in conjunction with the various exemplary embodiments outlined above, it is evident that many alternatives, modifications and variations will be apparent to those skilled in the art. Accordingly, the exemplary embodiments of the invention, as set forth above, are intended to be illustrative, not limiting. Various changes may be made without departing from the spirit and scope of the invention.

What is claimed is:

1. A radiation blocking device, comprising:
a substantially planar lead strip; and
a lead strip holder adapted to hold the lead strip and attach the lead strip to a stud such that when attached to the stud the lead strip blocks radiation through a wall joint.

2. The radiation blocking device of claim 1, wherein the lead strip further blocks radiation through at least one screw hole adjacent the wall joint.

3. The radiation blocking device of claim 1, wherein the stud is a metal C stud.

4. The radiation blocking device of claim 1, wherein the wall joint is a vertical wall joint.

5. The radiation blocking device of claim 4, wherein the lead strip holder is adapted to attach to an inside portion of the stud.

6. The radiation blocking device of claim 1, wherein the wall joint is a horizontal wall joint.

7. The radiation device of claim 6, wherein the lead strip holder is adapted to attach to an outside portion of the stud.

8. The radiation blocking device of claim 1, wherein adjacent sheets of lead each attached to a substrate abut at the wall joint, and the stud is attached to the adjacent sheets of lead.

9. The radiation blocking device of claim 1, wherein the lead strip holder includes a main body and a leg, wherein the leg is substantially perpendicular to the main body and is adapted to attach to an inside portion of the stud as the main body holds the lead strip substantially parallel to a wall.

10. The radiation blocking device of claim 9, wherein when the wall includes the adjacent sheets of lead.

11. The radiation blocking device of claim 10, wherein a line extending from the wall joint and substantially perpendicular to the wall will pass through the lead strip.

12. The radiation blocking device of claim 6, wherein the main body of the lead strip holder includes a U-shaped portion which frictionally fits onto an edge of the lead strip.

13. The radiation blocking device of claim 12, further comprising a plurality of clips adapted to further attach the lead strip holder to the inner portion of the stud.

14. The radiation blocking device of claim 13, wherein each of the clips includes a leg adapted to attach to the inner portion of the stud.

15. The radiation blocking device of claim 14, wherein each of clips further includes a U-shaped portion to frictionally fit onto the U-shaped portion of the lead strip holder.

16. The radiation blocking device of claim 1, wherein the lead strip is greater than about one-eighth inch in thickness.

17. A radiation blocking device, comprising:
a metal C stud arranged vertically; and
a substantially planar lead strip arranged horizontally and extending through the metal C stud;
wherein radiation from a horizontal wall joint is blocked by the lead strip.

18. The radiation blocking device of claim 17, further comprising an extension piece attached to an outer portion of the C stud.

19. The radiation blocking device of claim 18, further comprising a lead strip holder wherein the lead strip holder includes a main body adapted to hold the lead strip substantially parallel to a wall attached to the C stud and a leg adapted to be attached to the extension piece; and
a clip adapted to further secure the lead strip holder to the extension piece.

20. A radiation blocking device, comprising:
means for holding a lead strip; and
means for attaching the means for holding the lead strip to a C stud.
